(19) United States
(12) Patent Application Publication
(10) Pub. No.: US 2015/0339769 A1
(43) Pub. Date: Nov. 26, 2015

(54) SYSTEM AND METHOD FOR ENFORCING DATA INTEGRITY AND LOAN APPROVAL AUTOMATION BY MEANS OF DATA AGGREGATION AND ANALYSIS

(71) Applicant: C1 BANK, ST. PETERSBURG, FL (US)

(72) Inventors: Marcio deOliveira, Sarasota, FL (US); Trevor Burgess, St. Petersburg, FL (US); Vasyl Borysovych Martyniuk, St. Petersburg, FL (US); Nikolai Samteladze, St. Petersburg, FL (US); Patrick Ryan, Seminole, FL (US)

(73) Assignee: C1 BANK, ST. PETERSBURG, FL (US)

(21) Appl. No.: 14/285,166

(22) Filed: May 22, 2014

(51) Int. Cl. G06Q 40/02

(52) U.S. Cl. CPC G06Q 40/025

(57) ABSTRACT

Systems and methods permit the efficient and accurate aggregation and analysis of loan application data as well as the convenient display of the loan application data to a financial service provider. In one embodiment, a computing device associated with a financial service provider receives a loan application containing loan application data. The computing device performs a compliance and underwriting analysis and a verification analysis to validate inputs, authenticate customer identity, ensure compliance with regulatory requirements, and evaluate the risk posed by a loan application, among other features. If the verification analysis indicates that supplemental loan application data is required, the provider computing device generates an application status message identifying the required supplemental data. Following the compliance and underwriting analysis and the verification analysis, the provider computing device creates an electronic credit authorization document and generates an application decision message indicating approval or disapproval of the loan application.

### TECHNICAL FIELD AND BACKGROUND

The present invention relates generally to the field of loan origination, and more particularly, to systems and methods for automating the creation and review of loan applications.

Lending is an important part of business for many financial service providers. Financial service providers must be able to quickly and efficiently process large volumes of loan applications while complying with strict origination guidelines that are designed to meet regulatory requirements and minimize the risk to the financial service provider. Traditional methods of compiling relevant information and evaluating loan applications are labor-intensive and time-consuming. Additionally, traditional methods for compiling relevant information and evaluating a loan application often include a subjective component, and the process might not be standardized across an organization. Different loan officers often interpret origination guidelines differently, or the origination guidelines might vary depending on the amount and type of loan the borrower is seeking, among other factors. It would, therefore, be advantageous to provide an efficient, reliable mechanism for compiling and evaluating information relevant to making a lending decision and for presenting this information in a manner that facilitates evaluation of the loan application.

Accordingly, it is an object of the present invention to provide systems and methods that permit the efficient, accurate, and automated aggregating and analysis of loan application data. It is a further object of the present invention to provide systems and methods that verify the completeness, accuracy, authenticity, and risk of a loan application and the data it contains. It is another object of the invention to permit the convenient display of loan application information for review by a financial service provider.

### SUMMARY

According to one embodiment of the invention, a system and method for processing loan applications is provided. The method includes receiving by a computing device associated with a provider, a loan application containing loan data that includes at least customer data. The provider computing device performs a compliance and underwriting analysis and a verification analysis. If the verification analysis indicates that supplemental loan application data is required, an application status message identifying the required supplemental data is generated by the provider computing device. Following the compliance and underwriting analysis and the verification analysis, the provider computing device creates an electronic credit authorization document and generates an application decision message indicating approval or disapproval of the loan application.

With other embodiments of the invention, the output of the verification analysis can be a confidence score reflecting a probability that the loan application will be approved. If the confidence score is below a predetermined threshold, the provider computing device generates an application status message identifying the required supplemental data.

In one aspect of the invention, the provider computing device generates a standard output file for storing data associated with the loan application to a loan database associated with the provider, and the standard output file is stored in the loan database.

In another aspect of the invention, the compliance and underwriting analysis includes screening the customer data against a database of individuals or entities known to present an increased risk to the provider. The compliance and underwriting analysis can also include performing a due diligence analysis, a capacity analysis, a credit analysis, and a collateral analysis.

According to yet another aspect of the invention, the application decision message is transmitted to the customer computing device. The method can also include verifying a customer email address by transmitting to a computing device associated with a customer, an electronic communication containing a passcode. In other embodiments, the provider computing device receives one or more electronic signatures acknowledging review of the loan application.

### BRIEF DESCRIPTION OF THE DRAWINGS

Features, aspects, and advantages of the present invention are better understood when the following detailed description of the invention is read with reference to the accompanying figures, in which:

FIG. 1 is an exemplary hardware configuration for a system according to one embodiment of the invention;

FIG. 2 is an exemplary data flow diagram according to one embodiment of the invention;

FIG. 3 is an exemplary loan application process according to one embodiment of the invention;

FIG. 4 is an exemplary notification for initiating a customer email address verification;

FIG. 5 is an exemplary display screen for verifying a customer email address;

FIG. 6 is an exemplary communication for verifying a customer email address;

FIG. 7 is an exemplary display screen for verifying a customer email address;

FIG. 8 is an exemplary notification indicating successful verification of a customer email address;

FIG. 9 is an exemplary communication that provides access to a user interface where a customer can enter loan application information;

FIG. 10 is an exemplary electronic credit authorization document according to one embodiment of the invention;

FIG. 11 illustrates a simplified, exemplary neural network for calculating a confidence score; and

FIGS. 12A-B illustrates an exemplary process for performing a verification analysis according to one embodiment of the invention.

### DETAILED DESCRIPTION

The present invention will now be described more fully hereinafter with reference to the accompanying drawings in which exemplary embodiments of the invention are shown. However, the invention may be embodied in many different forms and should not be construed as limited to the representative embodiments set forth herein. The exemplary embodiments are provided so that this disclosure will be both thorough and complete and will fully convey the scope of the invention and enable one of ordinary skill in the art to make, use, and practice the invention.

Disclosed are systems and methods for automating in whole or in part the process of gathering and analyzing data required for a loan application. The systems and methods also present loan application data in a convenient format that facilitates efficient and accurate review by a financial service provider. In one embodiment, a customer can initiate a loan application by providing a minimal amount of information. The systems utilize automated communications to authenticate the customer's email address and provide access to a graphical user interface where the customer can complete a loan application or personal financial statement. After gathering loan application data from the customer, the systems perform a series of compliance and underwriting analysis techniques to authenticate customer identity and to evaluate the loan application. By automating the aggregation of loan application data and the compliance and underwriting analysis, the systems and methods of the present invention have significant advantages over traditional systems. The subjective components of a loan application review are minimized, and the loan application analysis can be performed accurately, reliably, and consistently across loan applications.

At various stages of the loan application process, the systems can perform a verification analysis to evaluate the completeness of the loan application data, the accuracy and authenticity of the loan application data, and the risk of the customer and the loan application. If deficiencies with the loan application are detected, the system can notify the customer or a provider associate that additional information or clarification is required. The customer is given the opportunity to provide additional information or amend the loan application data to address the deficiencies. This feedback cycle continues until the loan application is in a suitable condition for review by qualified provider associates or a provider loan review committee.

When the loan application is in a suitable condition for review, the systems create an electronic credit authorization document that includes all the information required to evaluate the loan application. This standardized credit authorization document facilitates reliable and consistent review of loan applications by ensuring that individuals associated with a financial service provider are reviewing the same loan application data in the same format. The loan application is approved, denied, or conditionally approved or denied pending the receipt of additional information. When the loan review is complete, the systems create a standard output file to “book” the loan—i.e., store it to a database on the financial service provider's core banking system.

The systems and methods find particular application in the processing of loan applications, but those of ordinary skill in the art will appreciate that the systems and methods can be applied to the processing of various other applications, such as new deposit account applications. Additionally, loan applications that can be processed include loans that cover a variety of transactions including: consumer lending, general personal finance lending, credit card lending, education lending, internet based lending, automobile lending, mortgage lending, equipment lending, small business lending, micro-loan lending, and other business finance lending.

The term financial service provider (“FSP”) generally describes a person or entity providing lending and other financial services and includes banks, credit unions, thrifts, alternative financial ser vice providers (“AFS”), or other types of financial institutions. The term FSP is used interchangeably with the terms provider, bank, or financial institution. The term associate is used interchangeably with the term representative and generally describes an individual employed by or associated with a provider and who provides service to customers and is involved in the loan application process. The term user describes an individual who utilizes the systems and methods of the present invention and can include financial service provider associates or customers. The term customer generally describes an entity or individual utilizing services offered by the financial service provider, and the term may be used interchangeably with the terms consumer, client, borrower, or applicant.

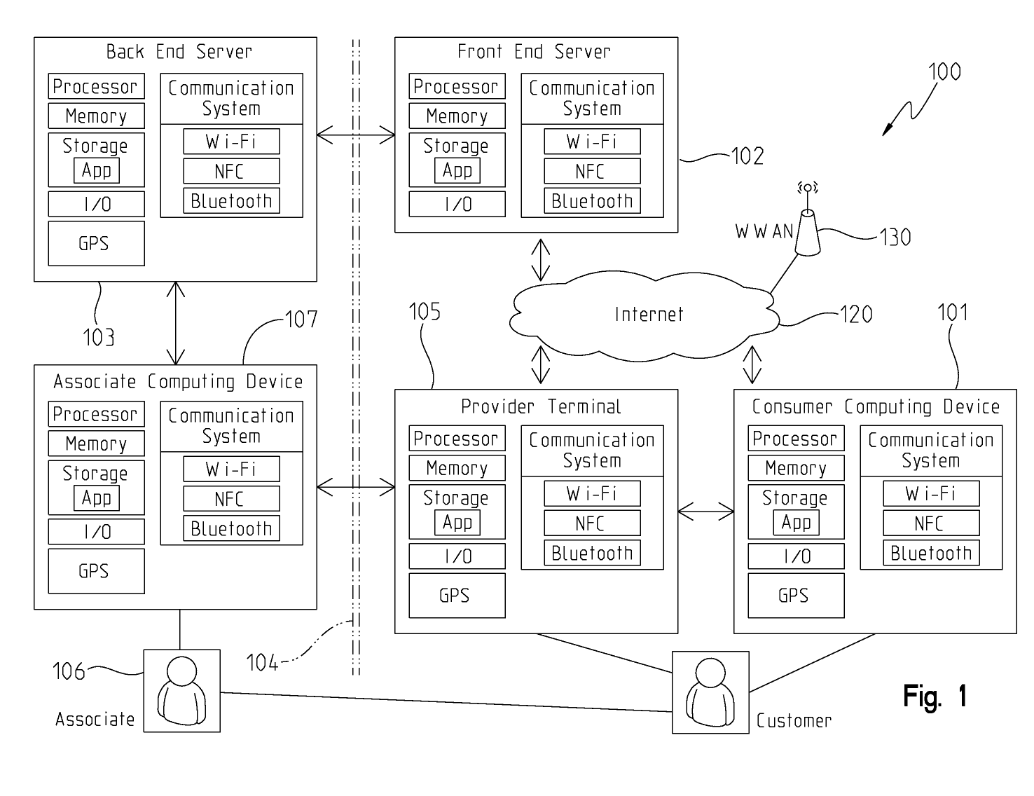

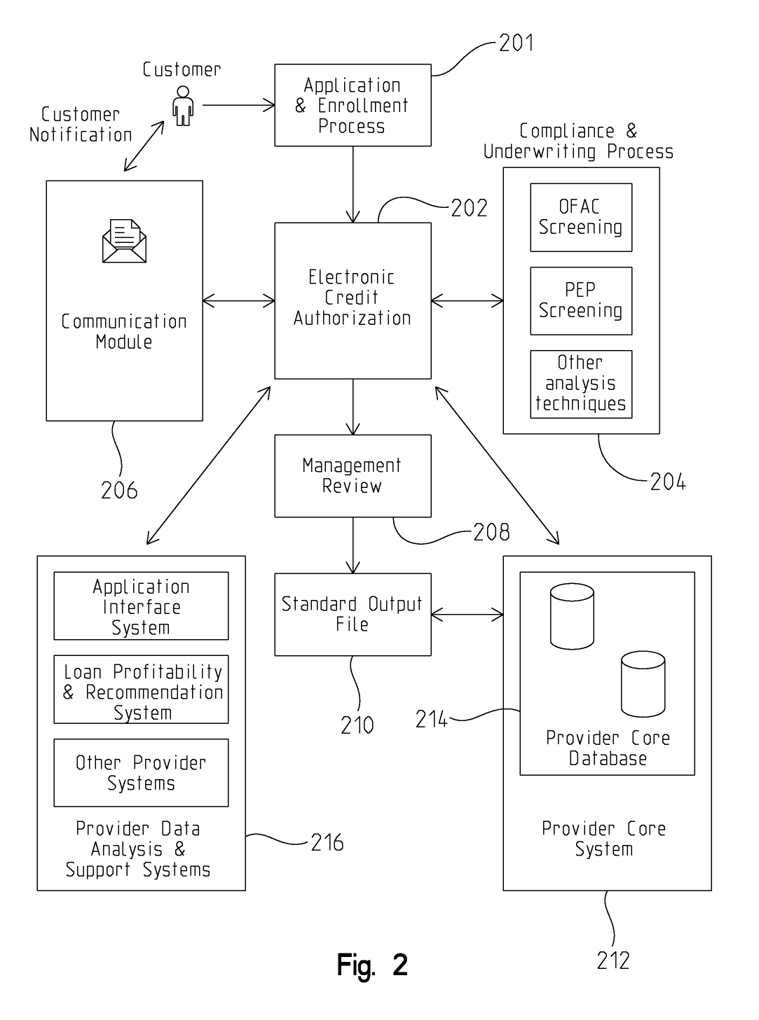

As shown in FIG. 1, a hardware configuration according to one embodiment of the invention generally includes a computing device 101 (e.g., an Internet-enabled device) operated by a customer and a computer system associated with a provider 100. The providers computer system 100 may include a front end server 102, a firewall 104, and back end server 103, and one or more computing devices 107 operated by the provider associates 106. The system 100 shown in FIG. 1 is not intended to be limiting, and one of ordinary skill in the art will recognize that the systems and methods of the present invention may be implemented using other suitable hardware or software configurations. For example, the system 100 may utilize only a single server implemented by one or more computing devices or a single computing device may implement one or more of the front end server 102, back end server 103, firewall 104, and/or associate computing devices 107.

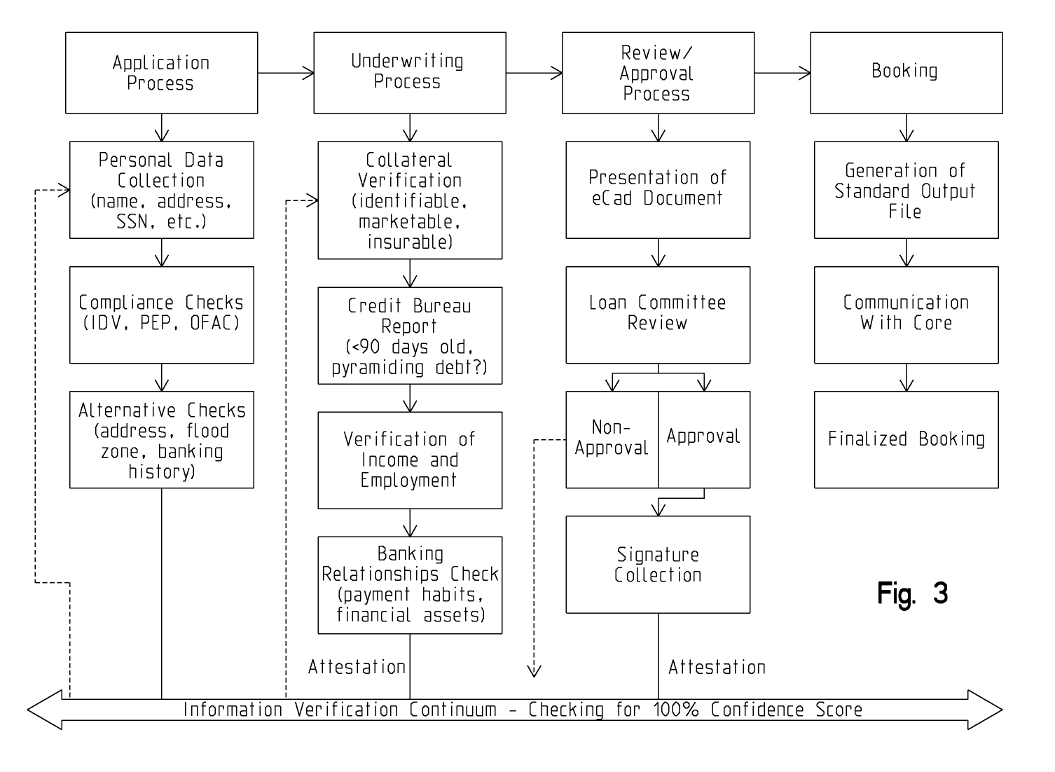

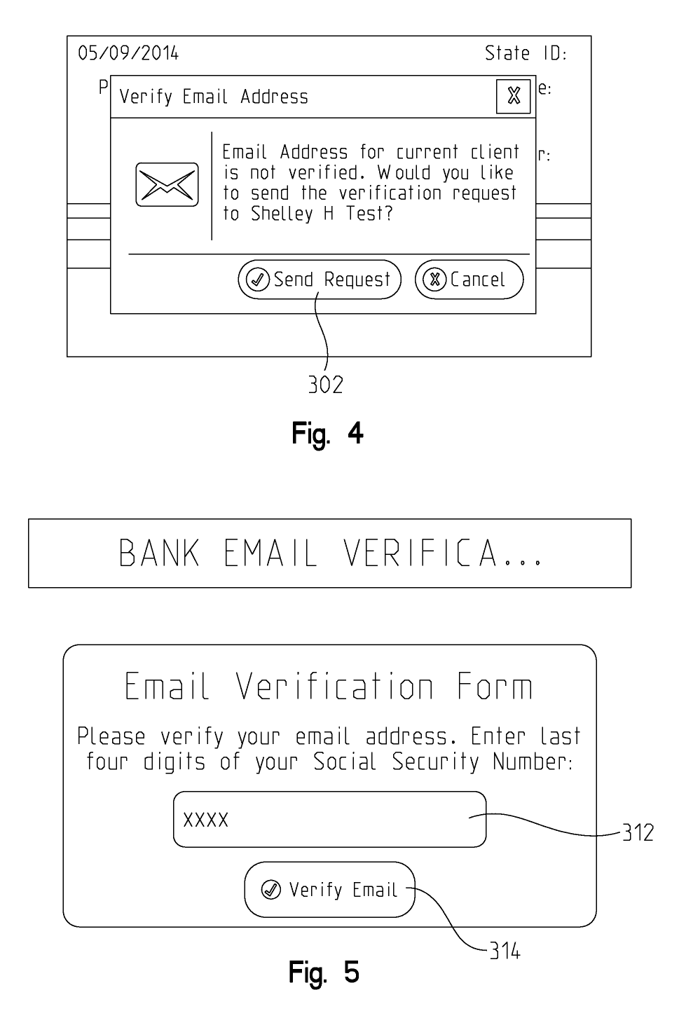

Further, a single computing device may implement more than one step of the methods described: a single step may be implemented by more than one computing device; or any other logical division of steps may be used. To illustrate, in looking at the exemplary data flow diagram shown in FIG. 3, the back end server 103 can implement the provider core system 212 as well as one or more of the electronic credit authorization module 202, communication module 206, or the compliance and underwriting processes 204. Alternatively, the system can utilize both the front end server 102 and the back end server 103 to implement, for example, the communications module 206. Or the system could utilize separate servers to implement the electronic credit authorization module 202 and the provider's core system 212.

Any suitable computing device can be used to implement the consumer computing device 101 or the components of the provider's computer system 100. The consumer computing device 101, the provider's servers 102-103, and the associate computing devices 107 may include a processor that communicates with a number of peripheral subsystems via a bus subsystem. These peripheral subsystems may include a storage subsystem, user-interface input devices, user-interface output devices, a communication system, a network interface subsystem, and a Global Positioning System (“GPS”). By processing instructions stored on one or more storage devices, the processor may perform the steps of the present method. Any type of storage device may be used, including an optical storage device, a magnetic storage device, or a solid-state storage device.

Typically, the consumer computing device 101 accesses the provider's computer system 100 over the Internet 120 in the normal manner—e.g., through one or more remote connections, such as a Wireless Wide Area Network (“WWAN”) 130 based on 802.11 standards or a data connection provided through a cellular service provider. These remote connections are merely representative of a multitude of connections that can be made to the Internet 120 for accessing the provider's computer system 100.

As illustrated in FIG. 1, a customer has the option to initiate a loan application and enrollment of credit through a variety of channels. By way of example, a customer is able to initiate a loan application using a consumer computing device 101 to access the providers computer system 100 through a provider website operated on the front end server 102. A customer can also initiate a loan application through a provider terminal 105, or the customer can engage a provider associate 106 by telephone or in person at a provider retail location. In one embodiment, a provider associate 106 utilizes a mobile computing device, such as a tablet computer, to gather information from the customer. The associate computing device 107 can include a magnetic card reader to gather information from a customer's driver's license, debit card, or credit card.

Regardless of how the customer initiates the loan application, the system prompts the customer or associate 106 using a series of questions or data fields to enter some or all of the data required to initiate a loan application. Loan application data can include customer biographical data, customer financial data, and data concerning the collateral property that is the subject of the loan. With traditional methods of completing a loan application, the process of collecting relevant documents and information from the customer is labor-intensive and time-consuming. Further, a customer initiating a loan application in person at a financial service provider's branch or retail location might not have all the necessary information on hand, which will require the customer to discontinue the application and complete it at a later time. This creates a burden for the provider and the customer and risks creating customer friction or losing the customer altogether.

By contrast, the application and enrollment process 201 of the present invention can be configured to allow the customer to conveniently complete a loan application in person or from a remote location after providing a limited amount of data to the financial service provider. In particular, a customer initiating a loan application in person at a provider branch can provide the associate 106 with an email address as well as other data relevant to the loan application.

After receiving initial information from the customer, the system optionally communicates with the provider's core system 212 to determine if the loan applicant maintains any financial accounts or other relationships with the provider. If other accounts or relationships exist, then the system gathers customer data from the provider's core database 214. This feature permits the passcode information to be gathered from the core system 212 if the applicant is an existing customer.

In one embodiment, the provider's core system 212 is implemented as a software application integrated with the back end server 103. The application performs core operations of banking, like recording transactions, passbook maintenance, interest calculations on loans and deposits, storing customer records, and balancing payments and withdrawals. This software is installed at different branches of a financial service provider and then interconnected by means of remote communication, like the Internet 120. Those of ordinary skill in the art will appreciate that the core system 212 can also be configured to perform a variety of other operations.

If the customer is not an existing provider customer or the customer's email address has not been verified by the provider, a software application integrated with the consumer or associate computing device 101 & 107 or the provider terminal 105 can display a notification, such as the notification shown in FIG. 3. The notification gives the user an option to verify the customer's email address. The email verification process is initiated by selecting the Send Request 302 function in FIG. 3. The system verifies the customers email address by, for instance, sending an email to the customer that contains a passcode and a website address or a hyperlink that takes the customer to a webpage where the customer can verify the email address. The passcode can be any suitable character string sufficient to provide a measure of security, such as a randomly generated number or information that only the customer would likely know. Suitable passcodes could include the last four digits of a customer's social security number or the customer's debit card personal identification number (“PIN”).

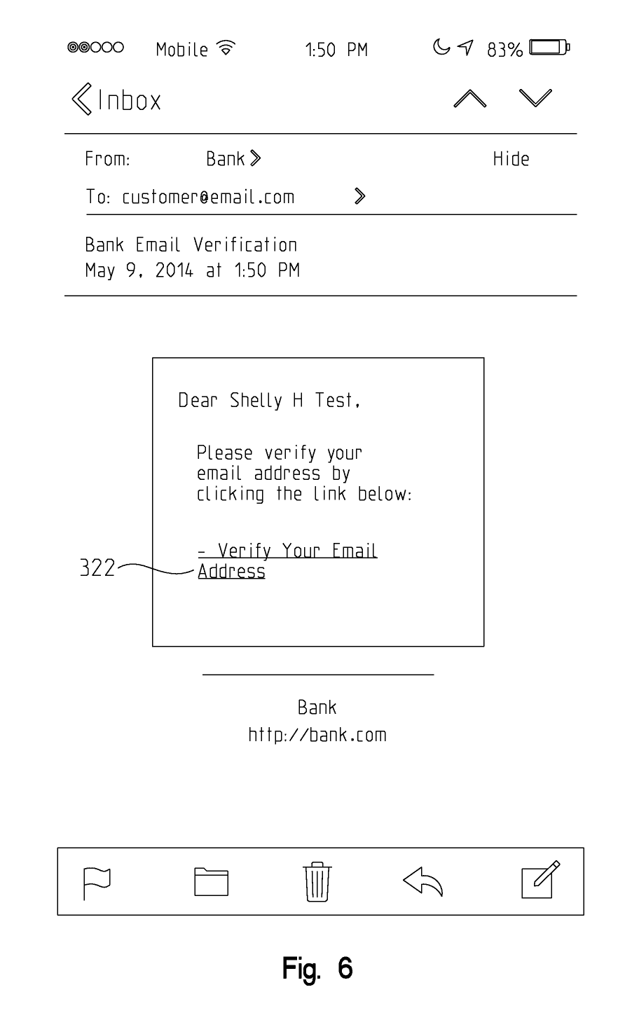

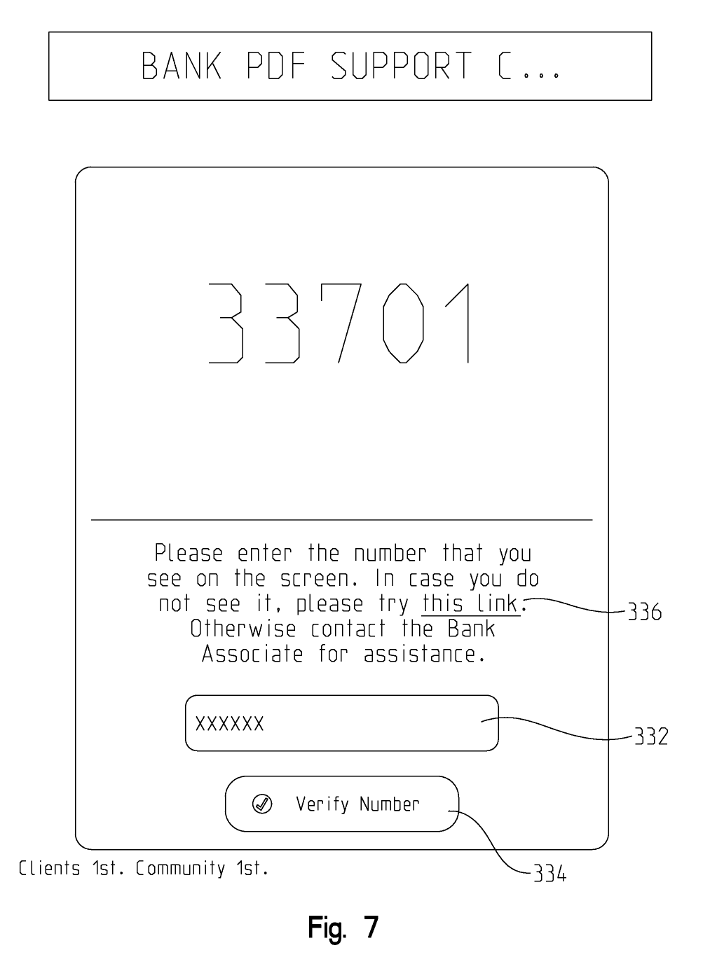

In the embodiment shown in the attached figures, selecting the Send Request 302 function opens a display screen, like the screen shown in FIG. 5. From the display screen shown in FIG. 5, the user can enter a passcode in a text box 312 before selecting the Verify Email function 314 to send a verification email. Upon selecting the Verify Email function 314, the communication module 206 transmits a verification email to the customer, such as the exemplary verification email shown in FIG. 6. The customer can continue with the email verification by selecting a hyperlink 322 in the body of the email that takes a customer to a verification display screen, such as the screen shown in FIG. 7. To verify the customer's email address, the customer enters a PIN number in a data-entry text box 322 and selects the Verify Number function 334. The PIN can be a predetermined number entered by the customer or a randomly generated number displayed in the verification email or on the verification display screen.

The verification display screen can optionally provide a help function accessible by selecting a hyperlink 336 or other function. The help function can assist the user by providing an alternative means for verifying the customer's email address, such as taking the customer to a webpage where the customer can initiate another verification email or enter other information that authenticates the customer's identity. The help function can also assist the user by directing the user to a display screen containing explanations of the different text boxes and data fields or explanations about other operations and functions of the system. Other methods of assisting a user may be provided through the help function, such as permitting users to download a document containing useful information.

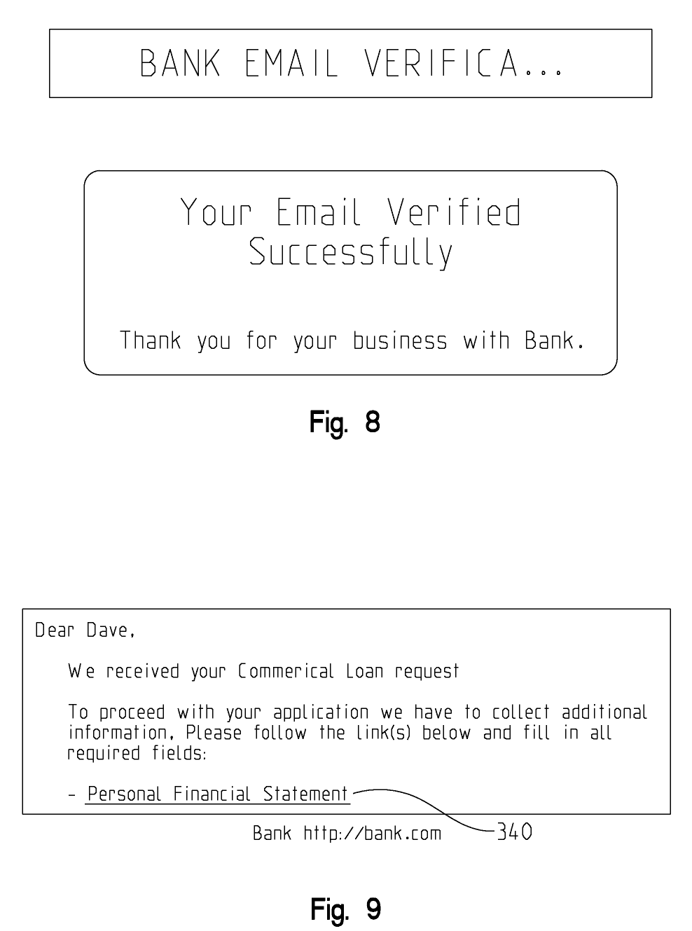

If the customers email address is successfully verified. Then a notification indicating successful verification is displayed, such as the notification shown in FIG. 8. One of ordinary skill in the art will appreciate that the exemplary functions and user-interface display screens disclosed herein are not intended to be limiting, and an integrated software application may include other display screens and functions.

Turning again to the application and enrollment process 201, after verifying the customer's email address, the customer can be provided access to a website or other graphical user interface (e.g., through a software application integrated with the consumer computing device 101) where the customer can complete a personal financial statement (“PFS”). From the graphical user interface, the customer can also provide further documents and information relevant to the loan application. Access to the graphical user interface can be provided by transmitting an email to the customer, like the email shown in FIG. 9, containing a link 340 to a webpage or software application where the customer can begin completing a PFS.

The loan application data required to complete a loan application varies according to a number of factors, such as the identity and characteristics of the customer, the type and amount of the loan requested, and the collateral property subject to the loan, among other factors. Examples of required customer biographical data can include: the customer's first and last name; tax identification number (e.g., social security number or employer identification number); mailing address; telephone number; facsimile number; and date of birth. Customer financial data includes, for example: customer income; information regarding the source and nature of the customer income (e.g., regular salary, hourly wage, commissions, self-employment income, etc.); liquid and other assets: debts and liabilities (e.g., mortgages, child support payments, judgments, etc.); and the length of time a customer has been employed at his or her current job.

The customer can also provide collateral data concerning the collateral property that will be subject to the loan, such as: the property address; the expected sale price; whether the property is residential, commercial, or industrial: whether the property is an owner-occupied home, second home, investment, or rental property: whether property is a single-family home, townhome, high-rise condominium, or commercial property; and any other relevant details regarding the property. A customer might also be asked to provide certain documents, such as government issued identification (e.g., a driver's license or passport), financial account statements, tax returns and supporting documents (e.g., W-2, Schedule E, C, or K-1), or business validation documents, like certified articles of incorporation and business licenses. Besides gathering information from the customer and the provider's core database 214, the system also obtains loan application data from a variety of other sources during the compliance and underwriting analysis 204. Other sources of loan application data can include public records, third-party service providers, or a combination of such sources. For instance, the system may search public records to determine whether the collateral property is subject to a lien or located in a flood zone.

After loan application data is received in connection with the loan application, the system can be configured to validate user inputs, including information input by a provider associate 106 or by the customer directly. To validate user inputs, the system reviews customer information in real time as it is entered and checks the information against a predetermined set of rules. Useful rules include notifying the user or automatically editing certain data fields when information is entered in an incorrect format. An example of such a rule is that the system can be configured to notify the user if a zip code does not contain at least five digits or if a social security number does not contain nine digits. Other input validation techniques include matching the zip code to the city listed in the address information and checking the social security number against a database to ensure that the number is valid.

The compliance and underwriting analysis 204 (“underwriting analysis”) includes performing one or a combination of identification authenticity, underwriting, and fraud assessment techniques, such as: account ownership verification (“AOV”); identity verification (“IDV”); identity authorization (“IDA”); a prior relationship analysis; United States Office of Foreign Asset Control (“OFAC”) screening; politically exposed person (“PEP”) screening; employment and income verification; a capacity analysis; a credit analysis; a collateral analysis; image scanning and validation: and customer enhanced due diligence (“EDD”). The compliance and underwriting analysis 204 is performed by the provider alone or in combination with third-party agencies, like fraud-detection or credit agencies.

The underwriting analysis 204 utilizes information received from a multitude of sources, including information entered by a customer, information obtained from third-party agencies (e.g., credit bureaus and insurers), and information obtained from public records. The underwriting analysis 204 can also utilize software tools and applications available through third-parties, such as the Instant Verify tool available through LexisNexis® used to authenticate identities and professional credentials or ACCELUS World Check available through THOMSON REUTERS. Typical sources of public records include, but are not limited to: court files; state and federal tax records; property records; U.S. Social Security Administration Verification Services; the Death Master File published by the U.S. Department of Commerce; and secretary of state filings from all fifty states. IDV techniques compare information obtained from third-party agencies and public records against information received from the customer. Inconsistencies in the data sets represent possible indicia of fraud or mistaken identity, which is relevant to assessing the customer risk level.

AOV techniques determine whether accounts with other financial institutions are a credible funding source. In one embodiment, the funding source is validated by sending a micropayment of a random amount to the funding source account and asking the customer to verify the amount of the deposit. In this manner, the provider determines in substantially real time whether the funding source account exists, whether the account is in good standing, and whether the customer has rights to the account.

IDA techniques present the customer with a series of questions about the customer's personal background that only the customer would know based on information obtained from third-party agencies or public records. As an example, a multiple choice question is generated using former addresses listed on a customer's credit report. The answer choices to the question include one former address and four randomly chosen addresses. The question is presented to the customer, and selection of the correct answer is a positive indicator that the customer's identity is authentic.

OFAC and PEP screening checks customer information against public or private databases of individuals known to present an increased risk to the provider or who are precluded by law from engaging in certain financial transactions. In the case of OFAC screening, the customer information is compared against a specially designated national list (“SDN List”) maintained by the U.S. OFAC of groups and individuals who are deemed to present a threat to national security and foreign or economic policy, such as terrorists, money launderers, organized crime affiliates, and narcotics traffickers. Politically exposed persons are individuals entrusted with a prominent public function and who are presumed to be at a higher risk for involvement in bribery and corruption as a result of their position and influence.

The OFAC SDN List entries and PEP database entries typically contain a full name, address, nationality, passport, tax identification number, place of birth, date of birth, former names and aliases, and other relevant information. The SDN List and PEP databases are searched using matching and scoring techniques that reduce the occurrence of false positive matches and that provide an instant pass/fail response. If, for instance, a customer's name matches a name on the U.S. OFAC's SDN List, the customer's current and former addresses, tax identification number, or other information is compared against information in the SDN List entry to determine whether or not the match is a false positive. Similarly, PEP screening checks customer information against databases of known heightened-risk individuals and businesses, such databases maintained by WorldCompliance®, a LexisNexis® affiliate.

The compliance and underwriting analysis 204 optionally incorporates employment and income verification. Current and previous employers are verified by contacting the employers to request written or oral verification or by comparing the employment history provided by a customer against the customer's tax records. A customer's reported income can be verified using tax records or by comparing the customer's reported income against databases of average incomes for the customer s particular profession or job.

Other compliance and underwriting analysis 204 techniques include reviewing documents, such as government-issued identifications or personal checks, or reviewing scanned images of such documents to ensure that the proper security features are present, such as holograms or watermarks printed on driver's licenses, passports, and personal checks.

Nondocumentary underwriting analysis techniques include verifying a customer's phone number or email by contacting the customer. One exemplary technique is to send the customer an email containing a hyperlink that takes the customer to a webpage where the customer confirms receipt of the email. This provides some assurance that the email account exists and that the customer has rights to the account.

The relationship analysis considers both positive and negative information predictive of risk and that relates to a customer's prior relationship with a financial service provider, such as, but not limited to, prior loan agreement and deposit account information. For instance, a large average deposit account balance is a positive indicator that the customer does not pose a high risk. On the other hand, multiple instances of overdraft or not sufficient funds (“NSF”) withdrawals indicates a higher risk. A history of timely payments on a prior loan with the provider is also a positive indicator of low risk while prior instance of default on a loan signals that (he customer likely poses a high risk. Those skilled in the art will appreciate that numerous factors bear on the risk level posed by a customer, and the exemplary factors discussed herein are not intended to be limiting.

Risk factors considered as part of a relationship analysis may be incorporated into a model that uses a set of logical rules to evaluate customer risk or considered as part of a quantitative risk assessment procedure. The implementation of a rule-based relationship analysis model can be better understood with reference to the following simplified example that uses a series of binary inquiries to classify the customer or loan application as high, moderate, or low risk. Exemplary inquiries ask whether: (1) the customer has a deposit account balance that has been maintained above a certain dollar threshold for a specified period of time (e.g., above 525,000 for over six months); (2) there has been no NSF withdrawals for a specified period; and (3) the customer has a prior loan with the provider that was paid in full with no instances of default.

If all of the inquiries are answered in the affirmative, the relationship analysis returns a pass result indicating that the customer or loan application might be classified as a low risk. But if any of the inquiries are answered in the negative, the relationship analysis returns a fail result, and the customer might be classified as a high risk. Continuing with this example, the rule-based model can be modified to require two negative answers before returning a fail or high risk result. Or a negative answer to one of the inquiries can return a result classifying the customer as a medium risk rather than a high risk to account for factors that are less predictive of risk. In other words, a provider might determine that instances of prior loan default correlate strongly to high risk customers but having an instance of a NSF withdrawal does not. Thus, the provider can incorporate a rule into the model requiring that a negative response to the NSF inquiry returns a result classifying the customer as a medium risk whereas a response to the default inquiry classifies the customer as a high risk.

Quantitative relationship analysis models can be implemented by assigning numeric scores to inquiry responses. The scores are added together, and an overall score that falls within a particular numeric range is translated to a corresponding risk level. In the example above, the presence of a prior default can be assigned a score of “10.” and a failure to meet the minimum balance requirement can be assigned a score of “2” to indicate that this factor is less predictive of customer risk. A customer with prior default and who did not meet the minimum balance requirement would have an overall score of “12.” If the provider's model dictated that an overall score of 0-5 is low risk, a score of 5-10 is moderate risk, and a score of 10-15 is high risk, the customer in this scenario might be considered a high risk.

The quantitative relationship analysis model could be further refined by modifying the inquiries to permit a range of possible responses with a range of numeric scores assigned based on the responses. So, for example, an average account balance between $20,001 and $25,000 over a specified time could be assigned a score of “5,” and an average account balance between $25,001 and $30,000 could be assigned a score of “3” indicating a lower risk. A model structured in this fashion would permit more precise calculations of risk. However, one of skill in the art will recognize that any suitable model can be used, and the model can consider a wide range of potential factors that bear on customer or loan application risk.

Another possible embodiment of the invention incorporates customer due diligence techniques as part of the compliance and underwriting analysis 204. Customer due diligence can be implemented as a series of inquiries directed to evaluating customer risk. For instance, a provider evaluating a loan application from a business customer can determine whether: the business site is local; the business has operated for at least two years; the business sends or receives international electronic funds transfers; the cash volume is appropriate for the business; the loan application is missing identification or other documents; and any other relevant information.

Each response is assigned a numeric score reflecting the risk posed by that factor. As an example, a response stating that the business has been operating less than two years is scored as a “5,” and a response stating that the business has been operating longer than two years is scored as a “1”. The responses to each inquiry can be scored the same (e.g., a “1” or a “5”), or the responses can be scored differently to reflect different weights assigned to each factor in determining customer risk. The scores for each response are summed to yield an overall score, and the customer is classified as a low, medium, or high risk based on whether the overall score falls within certain numeric ranges.

If the business customer falls within the medium or high risk category, the provider can further investigate the customer. The provider can contact the customer in person or by phone to evaluate circumstances such as whether: the individual who initiated the account opening is available; the business answers telephone calls in a professional manner; the business is appropriately staffed; the nature of the business matches information provided in connection with the loan application; or any other relevant factor. Once again, the responses are assigned a numeric score reflecting the risk posed by that factor, and the scores are summed to yield an overall score that gives further insight as to the customer's risk level.

A capacity analysis evaluates a customer's ability to make payments on a loan by examining the customer's employment, income, current debts, and assets. A capacity analysis considers not only the amount of income but also whether the income is derived from self-employment, commissions, or other sources that are considered riskier than a regular salary. A capacity analysis also considers a customer's debt-to-income (“DTI”) ratio. DTI is calculated by totaling a customer's monthly liabilities and obligations and dividing by the customer's monthly income. A higher DTI can be an indication that a customer poses a higher risk. Assets also factor into evaluating the customer's capacity, and customers with higher amounts of liquid assets are typically considered a lower risk.

A credit analysis evaluates, among other things, how well a customer manages current and prior debts, and the analysis generally relies on credit reports obtained from third-party credit bureaus. A credit report can contain information about the customer's credit score, current and prior credit cards, loans, collections, repossession, foreclosures, and information from other public records (e.g., tax liens, judgments, and bankruptcies).

The collateral analysis evaluates the nature and value of the property underlying the loan. The value of the property is determined through an appraisal and is used to determine a loan to value (“LTV”) ratio, which is the ratio of the loan amount to the value of the property. A higher LTV generally correlates to a higher risk. The nature of the collateral also bears on the risk of a loan. For instance, loans that are used to purchase a single family home or townhome are considered lower risk than loans used to purchase a high-rise condominium. And loans used to purchase owner-occupied homes or second homes are considered lower risk than loans that are used to purchase investment property.

The compliance and underwriting analysis 204 can also utilize other data analysis and support systems 216 maintained by the provider, such as a proprietary loan profitability and recommendation system that analyzes the profitability of the loan and provides recommendations on how to optimize loan terms to maximize customer retention and profitability. The systems can also interact with, for example, application programming interfaces maintained by the provider to promote secure access to third-party systems and software applications.

The systems and methods further include a verification analysis that helps ensure the reliability, accuracy, and integrity of the information utilized in the compliance and underwriting analysis 204 and the results of the analysis. The output of the verification analysis can be a confidence score that represents the probability that the loan application will be approved or successfully processed in the next stage of the loan application process. The verification analysis is performed continuously or at predetermined points during the lifecycle of the loan application process.

The verification analysis can be implemented using a quantitative model or logical rule-based approach where the existence of certain conditions leads to a predetermined effect on the verification analysis. To illustrate, the failure of an OFAC screening can cause the confidence score to automatically reach zero percent or result in the automatic denial of a loan application. Similarly, the failure of a PEP screening can cause the confidence score to be reduced by fifty percent and further cause the system to request additional information from the customer concerning the circumstances surrounding the PEP screening failure.

The verification analysis can consider a variety of factors, including: (1) the overall portion of the loan application that has been completed; (2) the accuracy of loan application data provided by the customer and gathered from other sources; (3) the authenticity of loan application data; (4) the risk level of the customer and the requested loan, as determined during the compliance and underwriting analysis 204; (5) the estimated profitability of the loan; (6) a financial service provider's diversification targets; (7) a providers risk profile; (8) the success of the particular associate 106 that initiated the loan application, such as a loan officer: and (9) any other factors relevant to evaluating a loan application.

The overall portion of an application that has been completed may be determined based on regulatory requirements or a financial service provider's policies. As an example, regulatory requirements and a provider's policies might require that loan applications for loans guaranteed by the United States Small Business Administration (“SBA”) must include certain data and information. In particular, the loan application might be required to include data demonstrating that the borrower is a small business that meets SBA size requirements and also that the principals have the requisite managerial and industry experience. The loan application might also require guarantees and attestations from the principals that they are jointly and severally liable for the loan.

The accuracy of the loan application is assessed by cross checking the data against external sources, such as through IDV techniques performed during the compliance and underwriting analysis 204. The authenticity of the loan application data is determined using controls that verify and attest that the loan application data was submitted and processed by the proper individuals. The customer's identity can be authenticated with techniques such as email verification, IDA, and reviewing government-issued identifications, among others. Both the customer and the provider associates 106 responsible for processing the loan application can be required to attest to the authenticity of their identities and that the loan application data submitted is accurate.

The profitability of the loan can be evaluated, for example, by determining an estimated risk-adjusted return on equity (“RAROE”). In one embodiment, the RAROE is calculated by dividing the average margin by the average capital used for the loan:

$$R A R O E = \frac{Average Margin}{Average Capital Used}$$

For each loan application, this RAROE may be expressed as a number, or it may be expressed as a qualitative assessment, such as “weak,” “normal,” or “strong.” Generally, the average margin is equal to the total margin divided by the loan life where the loan life is the maturity period plus the interest only period.

$$Average Margin = \frac{Total Margin}{Loan Life}$$

$$Loan Life = Maturity Period + Interest Only Period$$

The average capital used in the RAROE calculation is equal to the average outstanding balance multiplied by the loan interest rate.

Average Capital Used=Average Outstandings×Equity Rate

The average outstanding, as utilized in the “average capital used” formula, is calculated as an average of monthly outstanding balances during the loan life period. The monthly outstanding balance is determined based on calculated payment schedules with an equal payment every month. If a loan has different equity rates during the loan life period (e.g., loan with construction period), then a weighted sum of the “average capital used” value is used in the calculations.

$$Average Outstanding = \frac{{\sum }_{i = 1}^{N} Outstanding Balance}{N}$$

It is generally true that the average outstanding amount of funds is needed to fund a loan. However, noninterest bearing deposits that a customer keeps in a deposit account with the provider reduces the required funding. Thus, funded amount is calculated as:

Funded Amount=Average Oustanding−NIB Deposits

The total margin used in the RAROE calculation is the difference between loan revenue and loan cost. Loan revenue includes interest received during the life of the loan and any financial service provider fees collected at the time the loan is originated. The costs associated with a loan include a: (1) cost of funds (“COF”): (2) cost of reserves: and (3) cost of risk adjustment.

The COF for fixed interest rate loans can be determined based on a combined funds model. Funds are considered to come from two sources: (1) provider funds (e.g., deposits and provider capital); and (2) borrowed funds. The provider's cost of funds rate (“bank COF”) is considered to be constant through the loan life and is equal to the average cost of interest-bearing funds rate taken from a provider's Uniform Bank Performance Report (“UBPR”) or Consolidated Report of Condition and Income (“call report”) available through the United States Federal Financial Institutions of Examination Council (“FFIEC”).

Borrowed cost of funds (“borrowed COF”) is determined using the federal home loan bank rate (“FHLB”) curve based on the loan life. For example, if the loan life is five years, a five-year federal home loan bank rate (“FHLB rate”) is taken. The provider's management can change the proportion between provider funds and borrowed funds used to fund a loan, based on the specific provider's funding practices. In this model, risks associated with rate fluctuations are inherited from the FHLB curve. Thus, cost of funds is:

$$Cost of Funds = Funded Amount \times ( Bank Funds Fraction \times Bank C O F + Borrowed Funds Fraction \times Borrowed C O F )$$

Cost of reserves is caluclated as follows:

Cost of Reserves=Funded Amount×FAS5

The FAS5 (also known as ALLL Rate) is equal to the ratio of allowance for possible loan and lease losses to total loans and lease-financing receivables not held for sale. The FAS5 value is taken from the UBPR report.

The overall loan cost for the provider includes an adjustment that has to be made based on the risk associated with the loan. This risk can be quantified as a “cost of risk adjustment” which is calculated as:

Cost of Risk Adjustment=Funded Amount×Risk Adjustment

In the above calculation, risk rating adjustment is based on the loan's risk rating code. An exemplary risk rating code is identified and determined as follows:

| Risk Rating 31 (low risk): | Adjustment = | −0.1% (if FAS5 > 0.1%) |
|---|---|---|
| | | 0% (if FAS5 ≦ 0.1%) |
| Risk Rating 34 (medium risk): | Adjustment = | 0% |
| Risk Rating 37 (high risk): | Adjustment = | 0.1% |

Thus, the total margin used in the RAROE determination is calculated by simply subtracting total cost from received revenue.

$$Total Margin = ( Total Interest + Fee ) - ( Cost of Funds + Cost of Reserves + Cost of Risk Adjustment )$$

The probability that a loan application will be approved is also affected by a provider's lending strategy, diversification targets, and risk profile. A provider with a conservative risk profile might approve only low and moderate risk loans while a provider with a more aggressive risk profile seeking higher returns might determine that high risk loans are acceptable. A provider might also establish diversification targets whereby the provider seeks lo originate loans of a particular type (e.g., commercial, residential, personal finance, equipment lending, etc.). from particular geographic areas, or of certain amounts.

The verification analysis can further consider the past success of a particular provider associate 106 that initiated the loan application. The success of an associate 106 can be evaluated by considering metrics like the overall proportion of loan applications initiated by the associate 106 that have been previously approved by the provider or the default rates and profitability of prior loans initialed by the associate 106.

In one exemplary embodiment, a confidence score is calculated using multilayer neural network techniques. Among other advantages, neural network techniques allow providers to account for the nonlinear effects of certain variables on the calculation of a confidence score. For instance, it might be the case that a low risk loan has very little effect on the confidence score calculation (e.g., increases the score five percent), but a high risk loan has a much more significant impact (e.g., lowering the score by fifty percent). An exemplary neural network according to one embodiment of the invention is illustrated in FIG. 11.

Generally, a multilayer neural network utilizes an input layer, an output layer, and one or more intermediate layers. The layers are made up of nodes called neurons connected by synapses. The nodes are implemented by activation functions that act on weighted inputs provided by the synapses. The neurons sum the weighted synapses inputs and pass the summed total through the activation function. The activation functions often have a sigmoid shape, but they may also take the form of other nonlinear functions, piecewise linear functions, or step functions. The activation functions are often monotonically increasing, continuous, differentiable, and bounded. In addition to sigmoid functions, the neurons can also utilize radial basis functions, such as Gaussian functions, multiquadratic functions, or inverse multiquadratic functions, as well as any other suitable function known to those of ordinary skill in the art.

When implementing neural networks, it can be useful to normalize the input data. Because neural networks work internally with numeric data, binary data (e.g., the results of a OFAC screening) and categorical data (e.g., loan type) can be encoded in numeric form. Additionally, it may be advantageous to normalize input data so that all inputs have roughly the same scale. In one embodiment, the inputs for a neural network that are used to calculate a confidence score can be normalized in the range of negative one to positive one using a min-max normalization technique implemented by the following formula:

$${y}_{i} = \frac{2 {x}_{i} - ( {Max}_{i} - {Min}_{i} )}{( {Max}_{i} + {Min}_{i} )}$$

Here, Xi is the initial input value of attribute i. Maxᵢ and Minᵢ are respectively the maximum and the minimum values of attribute i in training data set. Skilled artisans will appreciate that other normalization techniques can be used, such as decimal scaling normalization.

Normalized inputs (Yi) are fed into the neural network to calculate a normalized confidence score (c). The actual confidence score C can be calculated from the normalized confidence score output (c) as follows:

C=1/2(Max*(1+c)+Min*(1−c))

The variables Max and Min are the maximum and the minimum confidence score values present in the training data set. Neuron nodes in the intermediate layer can utilize a sigmoid activation function to calculate node output Sj:

$${s}_{j} = \frac{1}{1 + {e}^{- {v}_{j}}}$$

Here, vⱼ is a weighted sum of the node j inputs, and Vj is calculated as:

vⱼ=w_{0,j}+Σw_{i,j}*Sᵢ

The value Wi,j is the weight assigned to the synapses between nodes I and j, and Wo,j is a threshold value for node j. The output neuron node uses a liner function to calculate the neural network output:

$${s}_{0} = {w}_{0 , 0} + {\sum }_{i = 1}^{3} {w}_{i , 0} * {s}_{i}$$

Neural networks can be trained utilizing test sets of inputs and corresponding outputs. In one embodiment, the inputs are run through the neural network, and the synapses weights arc calculated that minimize the sum squared error of the difference between the test outputs and the calculated outputs. Specifically, after the lest inputs are propagated forward through the neural network, the system computes the net input and output of each node in the intermediate and output layers and back propagates the error through the network. To illustrate a back propagation process, the output layer error can be calculated as:

Err₀=s₀(1−s₀)(T−s₀)

The variable T represents the true output from the test data set. The output error is propagated backwards by first calculating the error for a neuron node j in the intermediate layer.

Errⱼ=sⱼ(1−sⱼ)Σw_{i,j}*Err₀

Where Wi,j is the weight assigned to the synapses between nodes i and j. Lastly, the synapses weights can be updated using a fixed learning rate, L.

Δw_{i,j}=L(Errⱼ)S₀

w_{i,j}=Δw_{i,j}+w_{i,j}

Typically, the learning rate (L) is a constant between zero and one that mitigates against the possibility of getting stuck at a local minimum or maximum rather than a global minimum or maximum. The learning rate should be large enough so that learning does not occur too slowly, but it should be small enough to avoid oscillation between inadequate solutions. A general rule is to set the learning rate equal to one divided by “k” where k is the number of iterations through the training set (L=(1/k)).

After the synapses weights have been adjusted, the back propagation process is repeated to further refine the weights. The back propagation process is repeated a predetermined number of times, such as 500 iterations. Alternatively, the process can be repeated until ΔWi,j is below a certain threshold value or until actual outputs reach a certain acceptable value relative to the test outputs. The back propagation process can be performed on a limited data set of up to fifty values and still calculate a confidence score with ninety-five percent precision.

One of ordinary skill in the art will recognize that the back propagation training method discussed above is not intended to be limiting, and other training techniques can be used, such as simulated annealing, genetic optimization, evolutionary methods, expectation-maximization, nonparametric methods, and particle swarm optimization. Neural networks can also be trained using unsupervised learning techniques to discover patterns in input data where there is no corresponding or predetermined output test data.

In one aspect of the present invention, the neural networks can be refined or trained using historical decision data about prior loan applications processed by the provider. The decision data analysis provides feedback to the system in the form of a loan application decision—i.e., an application approval, rejection, or return for additional information. If, for example, a loan application is returned for additional information, it is assumed that the confidence score should have been approximately fifty percent. The loan application data and other associated data then serves as a lest input data set where the test output is fifty percent. This data is used to train the system and adjust the weights of the synapses. Feedback can also be generated by identifying the top two factors that affected a decision on a loan application. The weights for these factors can then be adjusted in the neural network to account for the importance of the factors in a loan application decision.

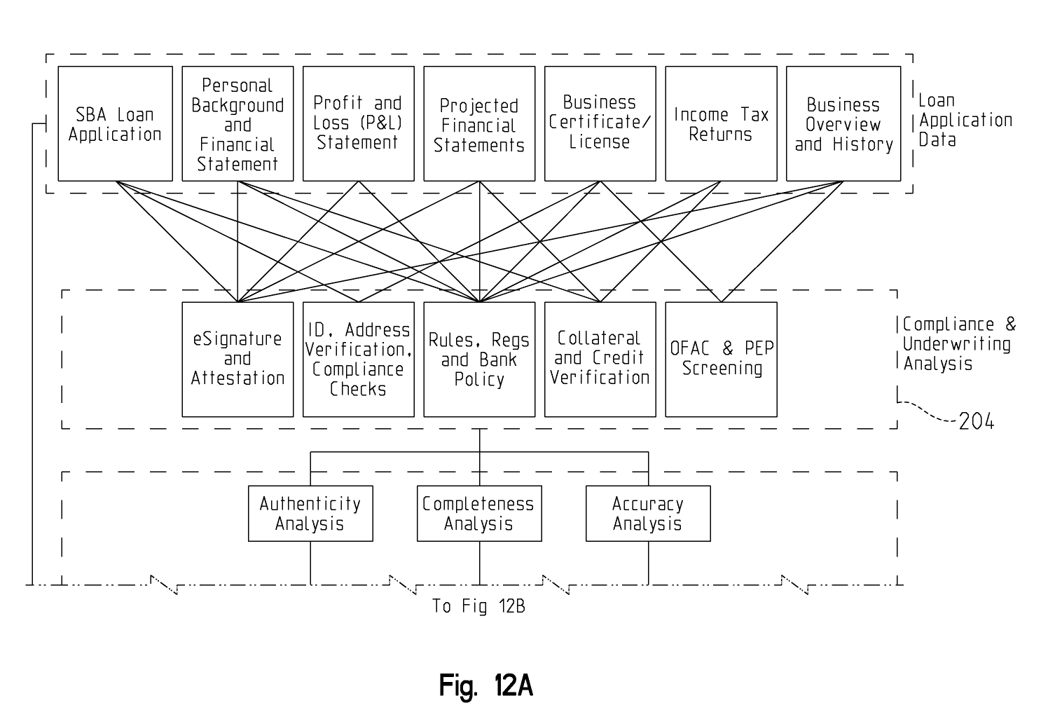

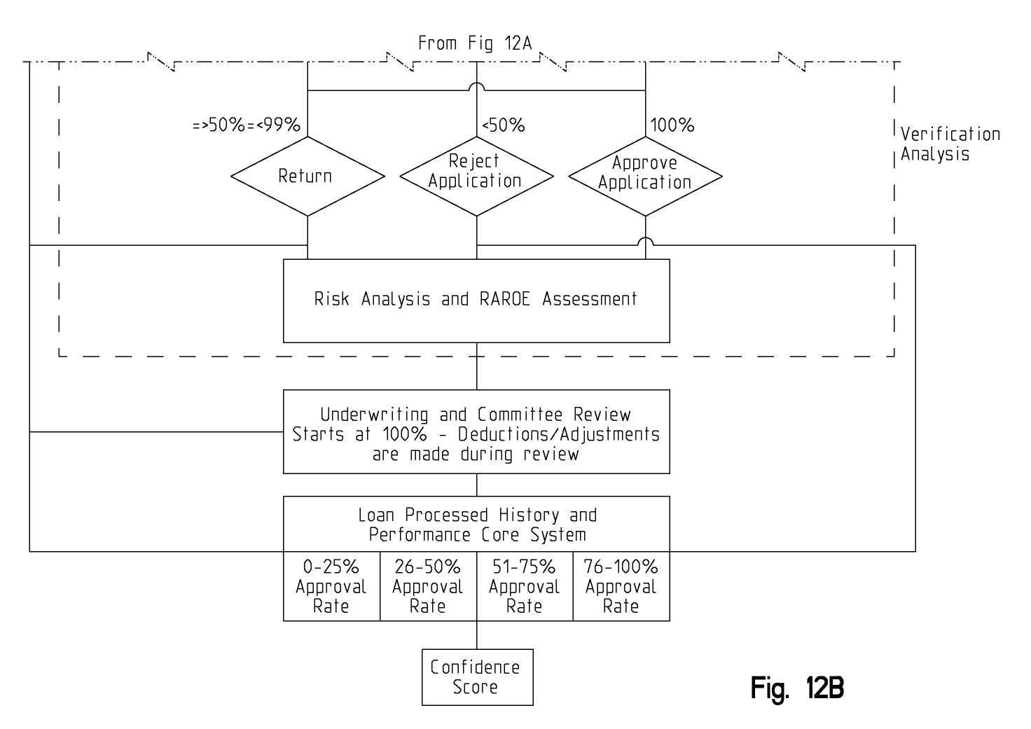

An exemplary process for calculating the confidence score is illustrated in FIGS. 12A-B. Loan application data is gathered and compliance and underwriting analysis 204 techniques are performed. A verification analysis is conducted using the loan application data and the results of the compliance and underwriting analysis 204. The exemplary verification analysis shown in FIGS. 12A-B includes evaluations concerning the authenticity, completeness, and accuracy of the loan application data, as well as a risk analysis and loan profitability assessment. Although the risk analysis is shown in FIGS. 12A-B as being conducted after a decision is made on the loan application, it should be recognized that a risk analysis can be performed throughout the loan application evaluation process. Generally, loan applications can be classified as high risk at the beginning of the evaluation process, and the risk level is reduced as the confidence score increases and approaches one-hundred percent.

Depending on the results of the verification analysis, the system can: (1) approve the loan application to proceed to the next stage of the evaluation process: (2) reject the loan application; or (3) return the loan application to the application and enrollment stage 201 to gather additional loan application data or seek clarification. The system can be configured so that certain actions are taken when the confidence score reaches predetermined thresholds set by the provider. In the embodiment shown in FIGS. 12A-B, the application proceeds to the next stage when the confidence score reaches one-hundred percent. If the confidence score is less than fifty percent, the loan application is rejected. When the loan application is rejected, the loan application data is saved to the provider's core database 214, and the loan application exits the system. In cases where the confidence score is between fifty percent and ninety-nine percent, the loan application is returned to the application and enrollment stage 201.

If the system determines that additional data is needed to evaluate the loan application, the communication module 206 transmits a communication to the customer seeking clarification or additional documents and information. The customer then has the opportunity to return to the website or graphical user interface used in the application and enrollment process 201 to provide supplemental data. By way of example, if the system determines that an expired policy is listed on a proof of insurance document submitted by a customer, the customer can be asked by email to submit an updated proof of insurance document. As another example, the provider's underwriting guidelines may require two years of continuous employment with the same employer but an analysis of employment history reveals that the customer frequently changes jobs after less than two years. In this case, the system may send an email asking the customer to submit a written explanation regarding the employment history, like the customer changed jobs to advance within the same line of work, or the customer was employed under a contract of limited duration.

Those of ordinary skill in the art will recognize that these examples are not intended to be limiting, and the customer can be given the opportunity to explain or submit supplemental data relating to a wide variety of issues. This includes issues such as requesting that a customer provide: (1) an organizational chart to explain the ownership of a complex trust: (2) requesting audited financial statements to provide more detail regarding the customer's ongoing business; and (3) an industry analysis to increase the provider's understanding of the competitive environment of the customer's business. The customer can also be provided with alternative means of providing supplemental data, such as responding to an email or proving the supplemental data in person at a provider location.

Once the customer provides the requested information, the system reruns part or all of the underwriting analysis 204 and recalculates the confidence score. This verification analysis feedback loop continues until the confidence score reaches one-hundred percent or another predetermined threshold deemed acceptable to the financial service provider. When the confidence score reaches an acceptable threshold, the process continues to the next stage of the loan application lifecycle. Alternatively, the provider can also specify certain acceptable deficiencies whereby the process will continue to the next stage even if the confidence score is not above the acceptable threshold. For example, if the confidence score is less than one-hundred percent because the customer's income could not be verified, the system could nevertheless move to the next stage if loan amount is below a certain dollar threshold or if the application is for a stated income loan where verification is not required.

The staged verification analysis approach can be better understood with reference to the exemplary embodiment shown in FIG. 3. The loan application process begins by receiving information from the customer, such as the customer's name, address, and social security number. This information is used to perform certain underwriting and compliance analysis 204 techniques, including an IDV, PEP screening. OFAC screening, address verification, a historical account data analysis, and a flood zone check. After performing these techniques, the system runs a verification analysis and calculates a confidence score, if the confidence score is returned as less than one-hundred percent because, for example, the customer entered an incorrect social security number causing the IDV to fail, the system sends an email to the customer providing notice of the deficiency. The email can also request that the customer provide supplemental data in the form of a correct social security number.

Once the customer provides a correct social security number, the IDV technique and verification analysis are performed a second time. If confidence score reaches a predetermined threshold, the system continues to the next stage of the exemplary loan application process in FIG. 3. At the next stage, the system performs a number of additional compliance analysis 204 techniques, including a collateral analysis, a credit analysis, employment and income verification, and a further relationship analysis. If the confidence score is acceptable, the loan application moves to the next stage for review by financial service provider associates 106 or a provider's loan committee.

Before the review stage, the system creates an electronic credit authorization document (“ECAD”) that includes all of the documents and information gathered and utilized during the application and enrollment process 201, the compliance and underwriting analysis 204, and the verification analysis. The ECAD can take a variety of forms. In one embodiment, the ECAD is created and configured to be accessible through a website that displays relevant loan application data and that provides hyperlinks to download relevant documents. The ECAD can also be created as a data file that is stored on a local computing device or a remote server and displayed by a software application integrated with the computing device.

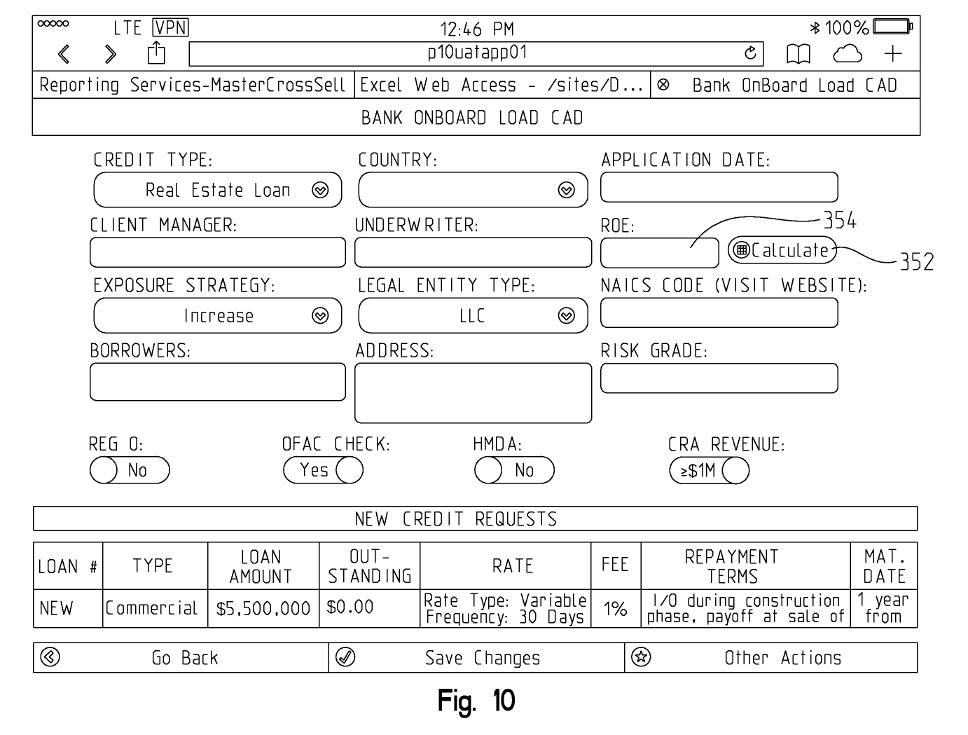

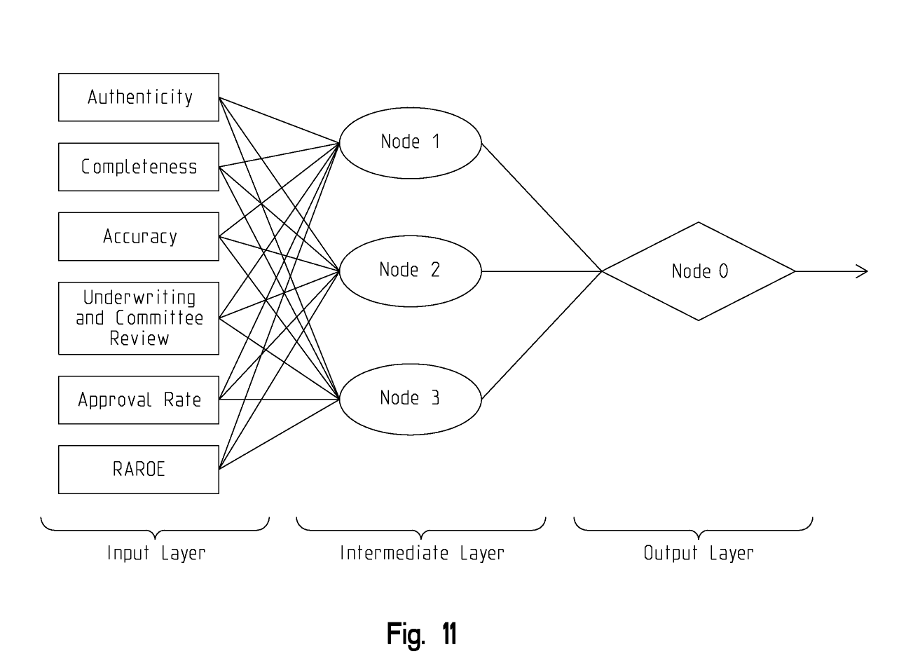

An exemplary ECAD is shown in FIG. 10 and contains data fields that display a variety of loan application data, including: (1) the type of loan requested (e.g., real estate loan for commercial entity); (2) the name and address of the customer; (3) location of the property that is the subject of the loan; (4) the terms of the loan, including the amount, duration, interest rate, and any associated fees; (5) the identity of the provider associates 106 responsible for managing the customer relationship and overseeing the underwriting process: (6) the risk of the customer or loan application; (7) whether compliance with certain laws and regulations is required or has been met, such as the Community Reinvestment Act, Home Mortgage Disclosure Act, OFAC screening, or Regulation O limiting the credit that providers can extend to certain principals; and (8) any other relevant information. The ECAD can also interface with other provider data analysis systems, like systems that can be used to analyze the profitability of the loan. In the exemplary ECAD shown in FIG. 10, a user can select the Calculate function 352 to determine an estimated return on investment 354 for the loan, which can be utilized during loan review.

The system can configure the ECAD so that priority data that is essential to making a decision to approve or disapprove a loan application is set aside for convenient display to a provider associate 106 or loan committee member. This facilitates accurate evaluation of the loan by ensuring that priority data is not overlooked during the evaluation. The identification of priority documents varies depending on the provider's policies and regulatory requirements, among other factors. As an example, a provider may determine that the results of the OFAC screening constitute priority data or that a business plan is a priority document for a loan that is to be guaranteed by the U.S. Small Business Administration (“SBA”). In embodiments where the ECAD is implemented as a webpage, this data can then be displayed at the top of the webpage. Alternatively, a link to the data could be included in a “pop-up” notification that is displayed when a user first accesses the ECAD and that the user must acknowledge to continue. The priority data can be set aside for review in any other suitable manner that promotes access to the data.

Continuing with the exemplary loan application process shown in FIG. 3, after creation of the ECAD, the ECAD is presented to the loan review committee for review 208. The application can then be approved, denied, or conditionally approved or denied pending receipt of supplemental data. If an application is conditionally approved or denied, then the communication module 206 can optionally send notice of the conditional decision and request for supplemental data to the customer or a provider associate 106 responsible for the loan application, such as a loan officer or client manager. Once the supplemental data is received, the loan application can be approved, or the system can reperform a verification analysis to determine if supplemental data permits the confidence score to meet the acceptable threshold for moving to the next stage. In some cases, moving the loan application to the next stage might require rerunning certain compliance and underwriting analysis 204 techniques or simply recreating the ECAD using the supplemental data before review by a provider associate 106 or a loan review committee.

If a loan application is unconditionally denied, the communication module 206 transmits a notice of denial to the customer and/or applicable provider associate 106. If the loan application is approved, the approval is indicated by collecting the required signatures, as required by provider policies and applicable regulations. The loan application can be signed manually or electronically. Signatures can be collected manually by printing, signing, and scanning the loan application. ECAD, or a signature page. Alternatively, the ECAD or other electronic loan application document can be signed electronically by, for example, providing users with a unique identification and password for accessing the ECAD, whereby users can input an acceptable electronic signature, such as the user's name preceded by “/s/” or surrounded by two slash “/” characters. The users can optionally be required to select a checkbox, radio button, or other input attesting that the user reviewed the loan application, understands the terms of the loan, and authorized the particular decision on the loan application.

The communication module 206 can be configured to facilitate the electronic signature process by transmitting notice to the relevant individuals indicating that an electronic signature is required. In one embodiment, notice can be transmitted by sending emails to previously authenticated email addresses associated with the individuals who are required to sign the application. The emails can also contain security features, such as a randomly generated PIN that is used to login to a website where the ECAD or loan application is displayed and available for signature. Once the first signature is obtained, the system can optionally “lock” the ECAD to preclude any further editing. This feature helps to ensure that each individual that signed and approved the loan application reviewed the same ECAD, thereby facilitating consistent and reliable evaluation of loan applications.

Once the signatures have been gathered and the loan application decision has been finalized, the system creates a standard output file 210 for “booking” the loan—i.e., storing the loan application data to the provider's core system 212 and recording the loan in the provider's financial ledgers. The system parses the loan application or ECAD document, categorizes the data, and creates an output file with data fields recognized by the core system 212. The loan application data and related information is then saved to the provider's core database 214.

Although the foregoing description provides embodiments of the invention by way of example, it is envisioned that other embodiments may perform similar functions and/or achieve similar results. Any and all such equivalent embodiments and examples are within the scope of the present invention.

What is claimed is:

1. A computer-implemented method of processing a loan application, comprising:
(a) providing a computing device associated with a provider;
(b) receiving by the provider computing device, a loan application containing loan data including at least customer data;
(c) performing by the provider computing device, a compliance and underwriting analysis;
(d) performing by the provider computing device, a verification analysis;
(e) if the verification analysis indicates that supplemental loan application data is required, generating by the provider computing device, an application status message identifying the required supplemental data;
(f) creating by the provider computing device, an electronic credit authorization document; and
(g) generating by the provider computing device, an application decision message indicating approval or disapproval of the loan application.

2. The method of claim 1, wherein;
(a) the output of the verification analysis is a confidence score reflecting a probability that the loan application will be approved; and
(b) the method further comprises the step of generating by the provider computing device, if the confidence score is below a predetermined threshold, an application status message identifying the required supplemental data.

3. The method of claim 1 further comprising the steps of:
(a) generating by the provider computing device, a standard output file for storing data associated with the loan application to a loan database associated with the provider; and
(b) storing by the provider computing device, the standard output file to the loan database.

4. The method of claim 1, wherein the compliance and underwriting analysis further comprises screening the customer data against a database of individuals or entities known to present an increased risk to the provider.

5. The method of claim 1, wherein the compliance and underwriting analysis further comprises performing a capacity analysis, a credit analysis, and a collateral analysis.

6. The method of claim 1, wherein the compliance and underwriting analysis further comprises performing a due diligence analysis.

7. The method of claim 1 further comprising the steps of:
(a) providing a computing device associated with a customer; and
(b) transmitting by the provider computing device, the application decision message to the customer computing device.

8. The method of claim 1 further comprising the step of verifying by the provider computing device, a customer email address by transmitting an electronic communication containing a passcode to a computing device associated with a customer.

9. The method of claim 1 further comprising the step of receiving, by the provider computing device, an electronic signature acknowledging review of the loan application.

10. A system for processing a loan application comprising:
a first processor associated with a provider;
a data storage device including a computer-readable medium having computer readable code for instructing the processor, and when executed by the processor, the processor performs operations comprising;
(a) receiving by the first processor, a loan application containing loan application data including at least customer data;
(b) performing by the first processor, a compliance and underwriting analysis;
(c) performing by the first processor, a verification analysis;
(d) if the verification analysis indicates that supplemental loan application data is required, generating by the first processor, an application status message identifying the required supplemental data;
(e) creating by the first processor, an electronic credit authorization document; and
(f) generating by the first processor, an application decision message indicating approval or disapproval of the loan application.

11. The system of claim 10 wherein:
(a) the output of the verification analysis is a confidence score reflecting a probability that the loan application will be approved: and
(b) the first processor is further configured to perform the operation of generating, if the confidence score is below a predetermined threshold, an application status message identifying the required supplemental data.

12. The system of claim 10, wherein the first processor is further configured to perform the operation of verifying a customer email address by transmitting to a second processor associated with a customer, an electronic communication containing a passcode.

13. The system of claim 10. wherein the first processor is further configured to perform the operations of:
(a) generating a standard output file for storing data associated with the loan application to a loan database associated with the provider; and
(b) storing the standard output file to the loan database.

14. The system of claim 10. wherein the compliance and underwriting analysis further comprises screening the customer data against a database of individuals or entities known to present an increased risk to the provider.

15. The system of claim 10, wherein the compliance and underwriting analysis further comprises performing a capacity analysis, a credit analysis, and a collateral analysis.

16. The system of claim 10, wherein the verification analysis further comprises performing a due diligence analysis.

17. The system of claim 10 wherein the first processor is further configured to perform the operation of transmitting the application decision message to a second processor associated with a customer.

18. The system of claim 10 wherein the first processor is further configured to perform the operation of receiving an electronic signature acknowledging review of the loan application.
